(19) United States
(12) Patent Application Publication
(10) Pub. No.: US 2024/0230185 A9
(43) Pub. Date: Jul. 11, 2024

(54) Gas-Liquid Separator and Compression System

(71) Applicant: ZHEJIANG DUNAN ARTIFICIAL ENVIRONMENT CO., LTD., Shaoxing, Zhejiang (CN)

(72) Inventor: Hailong JIN, Shaoxing, Zhejiang (CN)

(21) Appl. No.: 17/768,858

(22) PCT Filed: Aug. 12, 2020
(86) PCT No.: PCT/CN2020/108663

§ 371 Date: Apr. 14, 2022

(30) Foreign Application Priority Data
Oct. 15, 2019 (CN) 201910979446.6

(51) Int. Cl. F25B 43/00; B01D 46/42; F25B 41/22

(52) U.S. Cl. CPC F25B 43/003; B01D 46/4272; F25B 41/22; F25B 2400/23

(57) ABSTRACT

A gas-liquid separator and a compression system are provided. An outer cylinder, a filter assembly, a bracket and a one-way valve are arranged in the gas-liquid separator, an upper part of the outer cylinder is provided with an inlet, and a lower part of the outer cylinder is provided with an outlet; the filter assembly is arranged in the outer cylinder, and the filter assembly is provided with a valve port; the bracket is arranged below the filter assembly; and the one-way valve is arranged on the bracket, at least part of a structure of the one-way valve is located below the filter assembly, and at least part of the structure of the one-way valve is movably, wherein when a pressure difference between a region above the valve port and a region below the valve port reaches a predetermined value, the valve port is opened.

### CROSS-REFERENCE TO RELATED APPLICATION(S)

The present disclosure is a national stage application of International Patent Application No. PCT/CN2020/108663, which is filed on Aug. 12, 2020. The present disclosure claims priority to Patent Application No. 201910979446.6, filed to the China National Intellectual Property Administration on Oct. 15, 2019 and entitled “Gas-Liquid Separator and Compression System”.

### TECHNICAL FIELD

The present disclosure relates to a technical field of gas-liquid separators, and in particular to a gas-liquid separator and a compression system.

### BACKGROUND

A compression system includes a gas-liquid separator and a compressor, which communicate with each other, gas-liquid mixed fluid is separated by the gas-liquid separator, and a separated gas enters the compressor for compression. After the compressor is shut down, a part of high-pressure gas inside the compressor will return into the gas-liquid separator and is discharged from the gas-liquid separator to other pipelines or equipment, which will take a relatively long time to start the compressor again, thus affecting the working efficiency.

### SUMMARY

Some embodiments of the present disclosure provide a gas-liquid separator and a compression system, so as to shorten a start-up time of a compressor.

In order to solve the above problems, according to one aspect of the present disclosure, some embodiments of the present disclosure provide a gas-liquid separator, including: an outer cylinder, wherein an upper part of the outer cylinder is provided with an inlet, and a lower part of the outer cylinder is provided with an outlet; a filter assembly, arranged in the outer cylinder and provided with a valve port; a bracket arranged below the filter assembly; and a one-way valve arranged on the bracket, wherein at least part of a structure of the one-way valve is located below the filter assembly, and at least part of the structure of the one-way valve is movably to open or close the valve port, and when a pressure difference between a region above the valve port and a region below the valve port reaches a predetermined value, the valve port is opened to realize an unidirectional communication between the inlet and the outlet.

In some embodiments, the one-way valve includes: a valve core, movably arranged on the bracket to open or close the valve port; and an elastic member arranged on the bracket, wherein the elastic member is matched with a side of the valve core that is away from the filter assembly.

In some embodiments, the valve core includes a sleeve body and a sealing member arranged on an upper end of the sleeve body, the sealing member is used for sealing the valve port, the sleeve body sleeves on the elastic member, a lower end of the elastic member abuts against the bracket, and an upper end of the elastic member abuts against the sealing member.

In some embodiments, the bracket is provided with a guide groove, the lower end of the elastic member abuts against a groove bottom of the guide groove, the valve core is movably arranged in the guide groove, and an inner wall of the guide groove is configured for guiding the valve core.

In some embodiments, an inner wall of the guide groove is provided with a groove, a side wall of the groove is provided with a through hole, and a region above the bracket communicates with a region below the bracket by the through hole.

In some embodiments, the bracket includes a cylinder body, a bottom plate and a end plate, wherein the end plate is hollow and is connected to an inner wall of the outer cylinder, an upper end of the cylinder body is connected with the end plate, a lower end of the cylinder body is connected with the bottom plate, the bottom plate and the cylinder body form the guide groove in a surrounding manner, and both the groove and the through hole are located on the cylinder body.

In some embodiments, a plurality of through holes are provided, the gas-liquid separator further includes an output pipe, wherein the output pipe passes through the outlet of the outer cylinder, the output pipe is located below the bracket, the output pipe is used for outputting a separated gas, and a sum of radial areas of the plurality of through holes is greater than a radial area of a gas channel of the output pipe.

In some embodiments, the gas-liquid separator further includes an output pipe, wherein the output pipe passes through the outlet of the outer cylinder, the output pipe is located below the bracket, the output pipe is used for outputting the separated gas, and a radial area of the valve port is greater than a radial area of the gas channel of the output pipe.

In some embodiments, the filter assembly includes a filter screen, an annular structure and a support plate, wherein the annular structure is connected with an inner wall of the outer cylinder, the support plate is arranged on the annular structure, the filter screen is arranged on the support plate, and the support plate is provided with the valve port.

According to another aspect of some embodiments of the present disclosure, a compression system is provided. The compression system includes the above gas-liquid separator and a compressor, an outlet of the gas-liquid separator communicates with a gas inlet of the compressor.

By applying the technical solution of some embodiments of the present disclosure, the outer cylinder, the filter assembly, the bracket and the one-way valve are arranged in the gas-liquid separator, the upper part of the outer cylinder is provided with the inlet, and the lower part of the outer cylinder is provided with the outlet; the filter assembly is arranged in the outer cylinder, and the filter assembly is provided with the valve port; the bracket is arranged below the filter assembly; and the one-way valve is arranged on the bracket, at least part of the structure of the one-way valve is located below the filter assembly, and at least part of the structure of the one-way valve is movably to open or close the valve port, wherein when the pressure difference between the region above the valve port and the region below the valve port reaches the predetermined value, the valve port is opened to realize unidirectional communication between the inlet and the outlet. By the above settings, only when the pressure in the region above the valve port is greater than the pressure in the region below the bracket and the pressure difference reaches the predetermined value, the one-way valve can open the valve port for gas-liquid separation of mixed fluid. In other cases, the one-way valve can close the valve port, so as to avoid the reverse flow of the gas. The gas-liquid separator is applied to the compression system, after the compressor is shut down, the valve port of the gas-liquid separator is closed, so that the gas in the compressor is prevented from being discharged from the gas-liquid separator, thereby guaranteeing the pressure in the compressor. In this way, when the compressor is started again, a start-up speed can be accelerated, and the start-up time can be shortened.

### BRIEF DESCRIPTION OF THE DRAWINGS

The drawings constituting a part of the present disclosure are used for providing a further understanding of the present disclosure, and exemplary embodiments of the present disclosure and descriptions thereof are used for explaining the present disclosure, but do not constitute improper limitations of the present disclosure. In the drawings:

FIG. 1 shows a schematic structural diagram of a gas-liquid separator provided by an embodiment of the present disclosure (a valve port is closed);

FIG. 2 shows another schematic structural diagram of the gas-liquid separator in FIG. 1 (the valve port is open);

FIG. 3 shows a schematic diagram of a filter assembly in FIG. 1;

FIG. 4 shows a schematic structural diagram of a valve core in a one-way valve in FIG. 1; and

FIG. 5 shows a schematic diagram of a bracket in FIG. 1.

The above drawings include the following reference signs:
10. outer cylinder; 20. filter assembly; 21. valve port; 22. filter screen; 23. annular structure; 24. support plate; 30. bracket; 31. guide groove; 32. groove; 33. through hole; 34. cylinder body; 35. bottom plate; 36. end plate; 40. one-way valve; 41. valve core; 42. elastic member; 43. sleeve body; 44. sealing member; 50. output pipe.

### DETAILED DESCRIPTION OF THE EMBODIMENTS

A clear and complete description of technical solutions in the embodiments of the present disclosure will be given below, in combination with the drawings in the embodiments of the present disclosure. Apparently, the embodiments described below are merely a part, but not all, of the embodiments of the present disclosure. The following description of at least one exemplary embodiment is merely illustrative and is in no way used as any limitation to the present disclosure and its application or use. All of other embodiments, obtained by those of ordinary skill in the art based on the embodiments of the present disclosure without any creative effort, fall into the protection scope of the present disclosure.

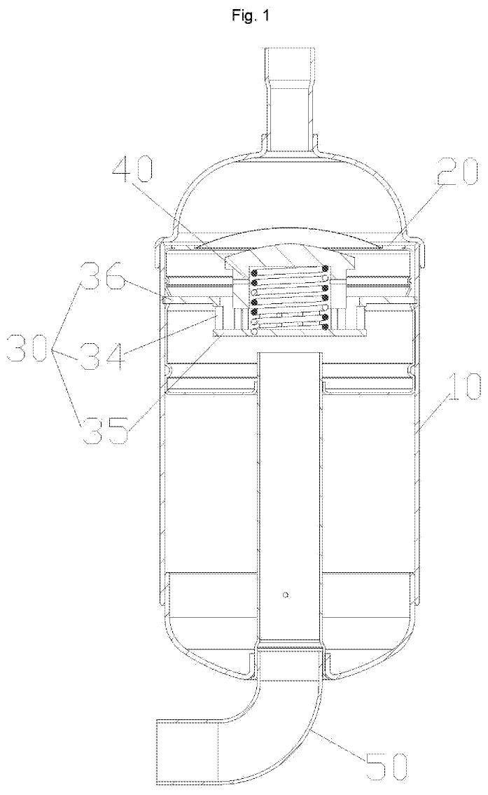

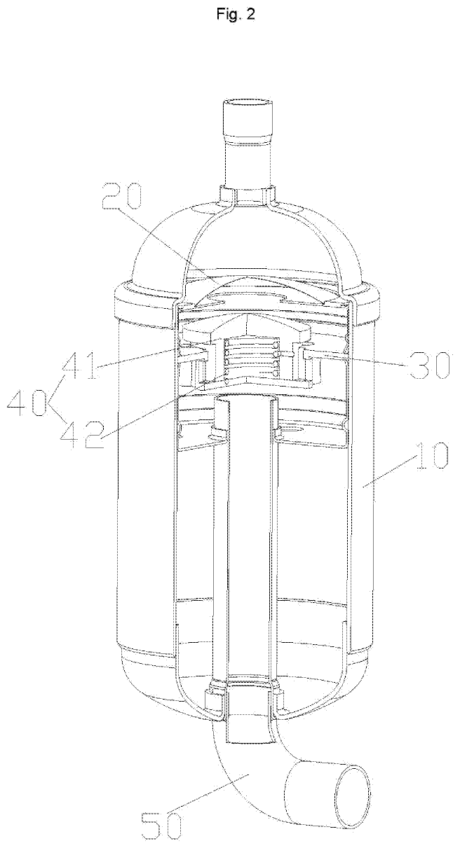

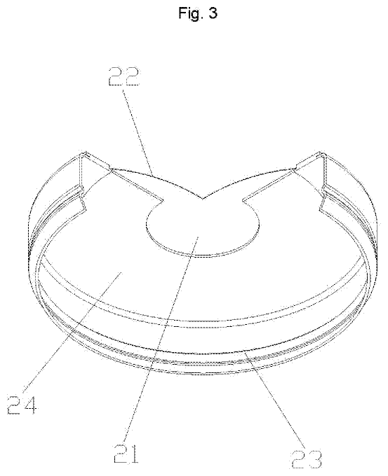

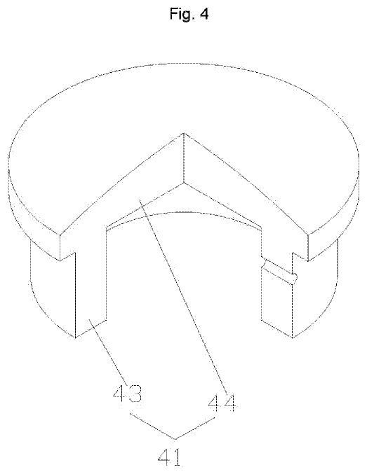

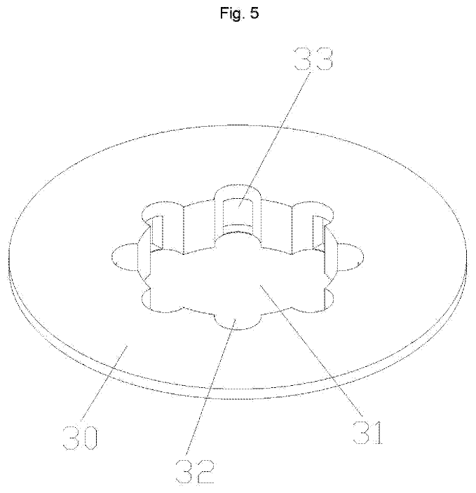

As shown in FIG. 1 to FIG. 5, one embodiment of the present disclosure provides a gas-liquid separator, including: an outer cylinder 10, wherein an upper part of the outer cylinder 10 is provided with an inlet, and a lower part of the outer cylinder 10 is provided with an outlet; a filter assembly 20, arranged in the outer cylinder 10 and provided with a valve port 21; a bracket 30 arranged below the filter assembly 20; and a one-way valve 40 arranged on the bracket 30, wherein at least part of the one-way valve 40 is located below the filter assembly 20, and at least part of the one-way valve 40 is movably to open or close the valve port 21, and when a pressure difference between a region above the valve port 21 and a region below the valve port 21 reaches a predetermined value, the valve port 21 is opened to realize unidirectional communication between the inlet and the outlet.

By applying the technical solution of some embodiments of the present disclosure, the outer cylinder 10, the filter assembly 20, the bracket 30 and the one-way valve 40 are arranged in the gas-liquid separator, the upper part of the outer cylinder 10 is provided with the inlet, and the lower part of the outer cylinder 10 is provided with the outlet; the filter assembly 20 is arranged in the outer cylinder 10, and the filter assembly 10 is provided with the valve port 21; the bracket 30 is arranged below the filter assembly 20; and the one-way valve 40 is arranged on the bracket 30, at least part of the structure of the one-way valve 40 is located below the filter assembly 20, and at least part of the structure of the one-way valve 40 is movably to open or close the valve port 21, wherein when the pressure difference between the region above the valve port 21 and the region below the valve port 21 reaches the predetermined value, the valve port 21 is opened to realize unidirectional communication between the inlet and the outlet. By the above settings, only when the pressure in the region above the valve port 21 is greater than the pressure in the region below the bracket 30 by the predetermined value, the one-way valve 40 can open the valve port 21 for gas-liquid separation of mixed fluid. In other cases, the one-way valve 40 closes the valve port 21, so as to avoid a reverse flow of the gas. The gas-liquid separator is applied to a compression system, after a compressor is shut down, the valve port 21 of the gas-liquid separator is closed, so that the gas in the compressor is prevented from being discharged from the gas-liquid separator, thereby guaranteeing a pressure in the compressor. In this way, when the compressor is started again, a start-up speed is accelerated, and the start-up time is shortened.

In some embodiments, the one-way valve 40 includes: a valve core 41, movably arranged on the bracket 30 to open or close the valve port 21; and an elastic member 42 arranged on the bracket 30, wherein the elastic member 42 is matched with a side, away from the filter assembly 20, of the valve core 41. In this way, when a downward pressure on the valve core 41 reaches a predetermined value, the valve core 41 moves downward against an elastic force of the elastic member 42, thereby opening the valve port; and when the downward pressure on the valve core 41 is less than the predetermined value or when the valve core is subjected to an upward pressure, the valve core 41 is maintained at a position for sealing the valve port under the elastic force of the elastic member 42. By the above settings, the unidirectional flow of the fluid in the outer cylinder 10 is realized.

In some embodiments, the valve core 41 includes a sleeve body 43 and a sealing member 44 arranged on an upper end of the sleeve body 43, the sealing member 44 is used for sealing the valve port 21, the sleeve body 43 sleeves on the elastic member 42, a lower end of the elastic member 42 abuts against the bracket 30, and an upper end of the elastic member 42 abuts against the sealing member 44. In this way, the cooperation between the valve core 41 and the elastic member 42 is easily realized. In some embodiments, the elastic member 42 is a spring.

In some embodiments, an upper surface of the sealing member 44 is a conical surface or an arc surface. In this way, a guide function is completed when the valve port 21 is sealed, and the sealing effect is improved.

In some embodiments, the sleeve body 43 is provided with a balance hole, so that internal and external pressures of the sleeve body 43 can be balanced by the balance hole.

In some embodiments, the bracket 30 is provided with a guide groove 31, the lower end of the elastic member 42 abuts against a groove bottom of the guide groove 31, the valve core 41 is movably arranged in the guide groove 31, and an inner wall of the guide groove 31 is used for guiding the valve core 41. By the above settings, a reliable installation of the valve core 41 is realized, and the movement of the valve core 41 can be guided and limited by the guide groove 31. In some embodiments, a shape of a side wall of the valve core 41 is cooperated with a shape of an inner wall of the guide groove 31. The guide groove 31 is a cylindrical groove, and at least part of a peripheral surface of the valve core 41 is a cylindrical surface.

In some embodiments, the inner wall of the guide groove 31 is provided with a groove 32, a side wall of the groove 32 is provided with a through hole 33, and a region above the bracket 30 communicates with a region below the bracket 30 by the through hole 33. In this way, after the valve port 21 is opened, the gas can be discharged from the groove 32 and the through hole 33.

In some embodiments, a radial section of the groove 32 is semicircular, a plurality of grooves 32 and a plurality of through holes 33 are provided, the plurality of grooves 32 and the plurality of through holes 33 are arranged in a one-to-one correspondence manner, and the plurality of grooves 32 are arranged around the valve core 41. This facilitates the flow of the fluid and avoids obstruction on the flow of the fluid caused by the setting of the one-way valve 40.

In some embodiments, the bracket 30 includes a cylinder body 34, a bottom plate 35 and a end plate 36, the end plate 36 is hollow and connected with the inner wall of the outer cylinder 10, an upper end of the cylinder body 34 is connected with the end plate 36, a lower end of the cylinder body 34 is connected with the bottom plate 35, the bottom plate 35 and the cylinder body 34 form the guide groove 31 in a surrounding manner, and both the groove 32 and the through hole 33 are located on the cylinder body 34. By means of the above settings, the assembly of the one-way valve 40 is facilitated, and the reliability of the gas-liquid separator is guaranteed.

In some embodiments, a plurality of through holes 33 are provided, the gas-liquid separator further includes an output pipe 50, the output pipe 50 passes through the outlet of the outer cylinder 10, the output pipe 50 is located below the bracket 30, the output pipe 50 is used for outputting a separated gas, and a sum of radial areas of the plurality of through holes 33 is greater than a radial area of a gas channel of the output pipe 50. By the above settings, a smooth flow of the fluid is guaranteed, and a problem that the obstruction on the flow of the fluid caused by setting the one-way valve 40 is avoided.

In the present embodiment, the gas-liquid separator further includes an output pipe 50, the output pipe 50 passes through the outlet of the outer cylinder 10, the output pipe 50 is located below the bracket 30, the output pipe 50 is used for outputting the separated gas, and a radial area of the valve port 21 is greater than that of the gas channel of the output pipe 50. By means of the above settings, the smooth flow of the fluid is guaranteed, and the obstruction on the flow of the fluid resulting from the setting of the one-way valve 40 is avoided.

In some embodiments, the filter assembly 20 includes a filter screen 22, an annular structure 23 and a support plate 24, the annular structure 23 is connected with an inner wall of the outer cylinder 10, the support plate 24 is arranged on the annular structure 23, the filter screen 22 is arranged on the support plate 24, and the support plate 24 is provided with the valve port 21, wherein the filter screen 22 is used for filtering the mixed fluid to realize gas-liquid separation, and the filter screen 22 can be fixed and supported by the annular structure 23 and the support plate 24.

In some embodiments, the filter screen 22 is of an arc-shaped structure, the support plate 24 is provided with a limiting groove, a periphery of the filter screen 22 is located in the limiting groove, and the limiting groove is used for filling solder to weld the support plate 24 and the filter screen 22. The outer cylinder 10 includes an upper cover, a middle cylinder and a lower cover, which are connected in sequence. The gas-liquid separator further includes an input pipe, and the input pipe passes through the inlet of the outer cylinder 10. The gas-liquid separator further includes a limiting ring, the limiting ring is arranged in the outer cylinder, and an end of the output pipe 50 passes through the limiting ring to limit the output pipe 50 by the limiting ring, so as to improve the stability of the device.

Another embodiment of the present disclosure provides a compression system. The compression system includes a compressor and a gas-liquid separator, an outlet of the gas-liquid separator communicates with a gas inlet of the compressor, and the gas-liquid separator is the gas-liquid separation described above. An outer cylinder 10, a filter assembly 20, a bracket 30 and a one-way valve 40 are arranged in the gas-liquid separator, an upper part of the outer cylinder 10 is provided with an inlet, and a lower part of the outer cylinder 10 is provided with an outlet; the filter assembly 20 is arranged in the outer cylinder 10, and the filter assembly 10 is provided with a valve port 21; the bracket 30 is arranged below the filter assembly 20; and the one-way valve 40 is arranged on the bracket 30, at least part of the structure of the one-way valve 40 is located below the filter assembly 20, and at least part of the structure of the one-way valve 40 is movably to open or close the valve port 21, wherein when a pressure difference between a region above the valve port 21 and a region below the valve port 21 reaches a predetermined value, the valve port 21 is opened to realize unidirectional communication between the inlet and the outlet. By the above settings, only when the pressure in the region above the valve port 21 is greater than a pressure in the region below the bracket 30 by the predetermined value, the one-way valve 40 can open the valve port 21 for gas-liquid separation of mixed fluid. In other cases, the one-way valve 40 can close the valve port 21, so as to avoid the reverse flow of the gas. The gas-liquid separator is applied to the compression system, after the compressor is shut down, the valve port 21 of the gas-liquid separator is closed, so that the gas in the compressor is prevented from being discharged from the gas-liquid separator, thereby guaranteeing the pressure in the compressor. In this way, when the compressor is started again, the start-up speed is accelerated, and the start-up time is shortened.

The above descriptions are only some embodiments of the present disclosure, and are not intended to limit the present disclosure. For those skilled in the art, the present disclosure can have various modifications and changes. For example, since the functions of the filter screen 22 and the valve port 21 are different and do not affect each other, in other embodiments, the filter screen 22 and the component provided with the valve port 21 can be completely designed separately, and then are installed in the outer cylinder 10 respectively. Or, even in other embodiments, the filter screen 22 is not provided, and only the one-way valve 40 and the matched valve port 21 are provided. Any modifications, equivalent replacements, improvements and the like, made within the spirit and principles of the present disclosure, shall all fall within the protection scope of the present disclosure.

What is claimed is:

1. A gas-liquid separator, comprising:
an outer cylinder, wherein an upper part of the outer cylinder is provided with an inlet, and a lower part of the outer cylinder is provided with an outlet;
a filter assembly, arranged in the outer cylinder and provided with a valve port;
a bracket arranged below the filter assembly; and
a one-way valve arranged on the bracket, wherein at least part of a structure of the one-way valve is located below the filter assembly, and at least part of the structure of the one-way valve is movably to open or close the valve port, and when a pressure difference between a region above the valve port and a region below the valve port reaches a predetermined value, the valve port is opened to realize an unidirectional communication between the inlet and the outlet.

2. The gas-liquid separator as claimed in claim 1, wherein the one-way valve comprises:
a valve core, movably arranged on the bracket to open or close the valve port; and
an elastic member arranged on the bracket, wherein the elastic member is matched with a side of the valve core that is away from the filter assembly.

3. The gas-liquid separator as claimed in claim 2, wherein the valve core comprises a sleeve body and a sealing member arranged on an upper end of the sleeve body, wherein the sealing member is used for sealing the valve port, the sleeve body sleeves on the elastic member, a lower end of the elastic member abuts against the bracket, and an upper end of the elastic member abuts against the sealing member.

4. The gas-liquid separator as claimed in claim 2, wherein the bracket is provided with a guide groove, the lower end of the elastic member abuts against a groove bottom of the guide groove, the valve core is movably arranged in the guide groove, and an inner wall of the guide groove is configured for guiding the valve core.

5. The gas-liquid separator as claimed in claim 4, wherein an inner wall of the guide groove is provided with a groove, a side wall of the groove is provided with a through hole, and a region above the bracket communicates with a region below the bracket by the through hole.

6. The gas-liquid separator as claimed in claim 5, wherein the bracket comprises a cylinder body, a bottom plate and a end plate, wherein the end plate is hollow and is connected to an inner wall of the outer cylinder, an upper end of the cylinder body is connected with the end plate, a lower end of the cylinder body is connected with the bottom plate, the bottom plate and the cylinder body form the guide groove in a surrounding manner, and both the groove and the through hole are located on the cylinder body.

7. The gas-liquid separator as claimed in claim 5, wherein a plurality of through holes are provided, the gas-liquid separator further comprises:
an output pipe, wherein the output pipe passes through the outlet of the outer cylinder, the output pipe is located below the bracket, the output pipe is used for outputting a separated gas, and a sum of radial areas of the plurality of through holes is greater than a radial area of a gas channel of the output pipe.

8. The gas-liquid separator as claimed in claim 1, wherein the gas-liquid separator further comprises:
an output pipe, wherein the output pipe passes through the outlet of the outer cylinder, the output pipe is located below the bracket, the output pipe is used for outputting the separated gas, and a radial area of the valve port is greater than a radial area of a gas channel of the output pipe.

9. The gas-liquid separator as claimed in claim 1, wherein the filter assembly comprises a filter screen, an annular structure and a support plate, wherein the annular structure is connected with an inner wall of the outer cylinder, the support plate is arranged on the annular structure, the filter screen is arranged on the support plate, and the support plate is provided with the valve port.

10. A compression system, wherein the compression system comprises a gas-liquid separator as claimed in claim 1 and a compressor, an outlet of the gas-liquid separator communicates with a gas inlet of the compressor.

11. The compression system as claimed in claim 10, wherein the one-way valve comprises:
a valve core, movably arranged on the bracket to open or close the valve port; and
an elastic member arranged on the bracket, wherein the elastic member is matched with a side of the valve core that is away from the filter assembly.

12. The compression system as claimed in claim 11, wherein the valve core comprises a sleeve body and a sealing member arranged on an upper end of the sleeve body, wherein the sealing member is used for sealing the valve port, the sleeve body sleeves on the elastic member, a lower end of the elastic member abuts against the bracket, and an upper end of the elastic member abuts against the sealing member.

13. The compression system as claimed in claim 11, wherein the bracket is provided with a guide groove, the lower end of the elastic member abuts against a groove bottom of the guide groove, the valve core is movably arranged in the guide groove, and an inner wall of the guide groove is configured for guiding the valve core.

14. The compression system as claimed in claim 13, wherein an inner wall of the guide groove is provided with a groove, a side wall of the groove is provided with a through hole, and a region above the bracket communicates with a region below the bracket by the through hole.

15. The compression system as claimed in claim 14, wherein the bracket comprises a cylinder body, a bottom plate and a end plate, wherein the end plate is hollow and is connected to an inner wall of the outer cylinder, an upper end of the cylinder body is connected with the end plate, a lower end of the cylinder body is connected with the bottom plate, the bottom plate and the cylinder body form the guide groove in a surrounding manner, and both the groove and the through hole are located on the cylinder body.

16. The compression system as claimed in claim 14, wherein a plurality of through holes are provided, the gas-liquid separator further comprises:
an output pipe, wherein the output pipe passes through the outlet of the outer cylinder, the output pipe is located below the bracket, the output pipe is used for outputting a separated gas, and a sum of radial areas of the plurality of through holes is greater than a radial area of a gas channel of the output pipe.

17. The compression system as claimed in claim 10, wherein the gas-liquid separator further comprises:
an output pipe, wherein the output pipe passes through the outlet of the outer cylinder, the output pipe is located below the bracket, the output pipe is used for outputting the separated gas, and a radial area of the valve port is greater than a radial area of a gas channel of the output pipe.

18. The compression system as claimed in claim 10, wherein the filter assembly comprises a filter screen, an annular structure and a support plate, wherein the annular structure is connected with an inner wall of the outer cylinder, the support plate is arranged on the annular structure, the filter screen is arranged on the support plate, and the support plate is provided with the valve port.
